(19) United States
(12) Patent Application Publication
(10) Pub. No.: US 2016/0189419 A1
(43) Pub. Date: Jun. 30, 2016

(54) SYSTEMS AND METHODS FOR GENERATING DATA INDICATIVE OF A THREE-DIMENSIONAL REPRESENTATION OF A SCENE

(71) Applicant: SWEEP3D CORPORATION, Waterloo (CA)

(72) Inventors: Adel FAKIH, Kitchener (CA); John ZELEK, Stratford (CA)

(73) Assignee: Sweep3D Corporation, Waterloo, Ontario (CA)

(21) Appl. No.: 14/911,152

(22) PCT Filed: Aug. 8, 2014
(86) PCT No.: PCT/CA2014/050757

§ 371 Date: Feb. 9, 2016

Related U.S. Application Data
(60) Provisional application No. 61/864,067, filed on Aug. 9, 2013.

(51) Int. Cl. G06T 15/20; G06T 17/00; G06T 7/00; G06T 15/08

(52) U.S. Cl. CPC G06T 15/20; G06T 15/08; G06T 17/005; G06T 7/0061; G06T 2200/04; G06T 2200/08; G06T 2215/16; G06T 2207/10028; G06T 2207/20164; G06T 2207/30244; G06T 2207/20072; G06T 2207/20076

(57) ABSTRACT

According to one aspect, there are systems and methods for generating data indicative of a three-dimensional representation of a scene. Current depth data indicative of a scene is generated using a sensor. Salient features are detected within a depth frame associated with the depth data, and these salient features are matched with a saliency likelihoods distribution. The saliency likelihoods distribution represents the scene, and is generated from previously-detected salient features. The pose of the sensor is estimated based upon the matching of detected salient features, and this estimated pose is refined based upon a volumetric representation of the scene. The volumetric representation of the scene is updated based upon the current depth data and estimated pose. A saliency likelihoods distribution representation is updated based on the salient features. Image data indicative of the scene may also be generated and used along with depth data.

### TECHNICAL FIELD

The embodiments herein relate to imaging systems and methods, and in particular to systems and methods for generating data indicative of a three-dimensional data representation of a scene.

### BACKGROUND

Images or photographs, like those captured using a conventional film or digital camera, provide a two dimensional representation of a scene. In many applications, a three-dimensional (“3D”) representation of a scene would be preferred. There are 3D scanners that facilitate generation of three-dimensional data representing a given scene. However, these 3D scanners are often intended for industrial use and they tend to be bulky and expense.

Generally, 3D scanners that are portable are preferred over less-portable scanners, because the portable 3D scanners can be easily transported to location where the scanning will occur. Furthermore, scanners that are designed for handheld use may be more useful since it is possible to move the scanner relative to the scene rather than moving the scene relative to the scanner. This may be particularly useful in situations where it is not desirable or possible to move a scene relative to the 3D scanner. Another challenge for 3D sensors is affordability. While there are many commercially available 3D sensors, they tend to be out of the price range of many consumers.

A real-time portable 3D scanning system may be capable of obtaining 3D data in real-time (i.e. “on the fly”) and render the captured data in real-time. The term “real-time” is used to describe systems and devices that are subject to a “real-time” constraint. In some cases, the real-time constraint could be strict in that the systems and devices must provide a response within the constraint regardless of the input. In some cases, the real-time constraint could be less strict in that the systems and devices must provide a response generally within the real-time constraint but some lapses are permitted.

To provide a 3D scanning system that can obtain 3D data in real-time and render the captured data in real-time, the system should provide fast and accurate tracking sensor position, fast fusion of range information and fast rendering of the fused information from each position of the sensor.

The above problems are closely related to the real-time Simultaneous Tracking and Mapping (SLAM) problem (for e.g. as described by H. Durrant-Whyte and T. Bailey in Simultaneous localization and mapping: part i. Robotics & Automation Magazine (IEEE, 13(2):99-110, 2006), which refers to simultaneously building a representation of the scene in which a sensor is moving (map) and localizing the sensor position at each time instant with respect to this map. Colour images based SLAM work mostly with salient visual features (i.e, regions of the image that are salient and distinctive from their surrounding (corners, blobs, etc. . . . ).

The salient features are detected by a 2D feature detection algorithms such as FAST (as described by E. Rosten and T. Drummond in Machine learning for high-speed corner detection, Computer Vision—ECCV 2006, pages 430-443, 2006); SIFT (as described by D. G. Lowe in Object recognition from local scale-invariant features, in Computer Vision, 1999, The Proceedings of the Seventh IEEE International Conference at volume 2, pages 1150-1157. IEEE, 1999); and SURF (as described by H. Bay, T. Tuytelaars, and L. Van Gool. in Surf: Speeded up robust features. Computer Vision—ECCV 2006, pages 404-417, 2006).

To be able to match those salient features in different images, descriptors that captures the distinctiveness of the image content around the salient point are built with focus on invariance to viewpoint, scale and lighting conditions. The working mode of visual SLAM is to represent the scene by the sparse set of the 3D locations corresponding to these salient image features, and use the repeated occurrence of these features in the captured images to both track the sensor positions with respect to the 3D locations and at the same time update the estimates of the 3D locations. Dense scene is possible to build afterward by fusing depth from either stereo or optical flow using the estimated positions from SLAM.

For range (i.e. depth data) images, the SLAM problem is tackled differently. Traditionally, the Iterative Closest Point (“ICP”) Algorithm (for e.g. as described by P. J. Besl and N. D. McKay in A method for registration of 3-d shapes, IEEE Transactions on pattern analysis and machine intelligence, 14(2):239-256, 1992) or one of its variants has been the algorithm of choice for tracking range sensors and for registering range data since its inception in 1992. The SLAM problem for depth data can be solved by determining the displacements of the sensor between a couple of adjacent frames by registering those frames using ICP. A pose graph is built from a set of chosen “Keyframes” and optimized at loop closures using techniques such as Toro (as described by G. Grisetti, C. Stachniss, and W. Burgard in Nonlinear constraint network optimization for efficient map learning, Intelligent Transportation Systems, IEEE Transactions on, 10(3):428-439, 2009) and g2o (as described by R. Kummerle, G. Grisetti, H. Strasdat, K. Konolige, and W. Burgard. g2o: A general framework for graph optimization, in Robotics and Automation (ICRA), 2011 IEEE International Conference on, pages 3607-3613. IEEE, 2011). Then, a depth map of the scene is built by fusing every frame using approaches such as surfels (as described by H. Pfister, M. Zwicker, J. Van Baar, and M. Gross in Surfels: Surface elements as rendering primitives, In Proceedings of the 27th annual conference on Computer graphics and interactive techniques, pages 335-342. ACM Press/Addison-Wesley Publishing Co., 2000.)

While the ICP method may be suitable for robotics applications, it may not be suitable for application to 3D scanning. The ICP method, which for example runs at about 1 Hz, may be too slow for 3D scanning applications. For example, if the 3D scanner is moved rapidly, the ICP method might not be able to reconcile two different frames that are not physically proximate.

Additionally, while ICP is in general very robust for the 3D point clouds collected by 3D laser scanning systems such as panning SICK scanners or 3D Velodyne scanners, it is not as robust for RGB-D images collected with commodity depth and image sensors such as Kinect™ sensors produced by Microsoft and/or Time of Flight cameras. In particular, applying ICP to RGB-D data may cause problems, especially at loop-closure.

Furthermore, map building within the ICP may preclude the user from observing the captured 3D data from the scanning process in real-time. Being able to observe the captured 3D data provides feedback to the user and allows the user to adjust the scanning processing accordingly.

The first problem has been addressed by Rusinkiewicz and Levoy in Efficient variants of the ICP algorithm in 3-D Digital Imaging and Modelling (Proceedings of the Third International Conference, pages 145-152. IEEE, 2001), which relies on the Projection-based matching and the Point-to-plane error metric to speed-up the registration. This can be further sped up by using the linear least squares optimization described by Low (K. L. Low, Linear least-squares optimization for point-to-plane ICP surface registration. no. February, pages 2-4, 2004). This algorithm can be extended for use with 3D scanning systems. However the sped-up algorithm is not as accurate as other ICP variants. Therefore the system is first used to capture online a coarse model, which is then refined later on offline using more accurate ICP variants. This may be unsatisfactory for a user who does not wish to subject the data to further processing.

A number of approaches that involve visual features in addition to ICP have tried to solve the second problem. However, instead of using them for mapping as in visual SLAM and maintaining their 3D positions as in visual SLAM, they are used only for visual odometry (i.e., to determine the sensor pose between successive frames rather than with respect to the map.) Image features that are detected within successive frames can be used to determine the camera transformation. The scene reconstruction (depth fusion) can be done using various means. Another similar approach involves transforming every depth frame into a surfels map and build a 3D descriptor for each surfel using the Point Feature Histogram (PFH). Those descriptors allow them to match the surfels and perform registration even across large displacements.

The third problem (i.e. that the map building does not allow the user to observe the scanning on the fly) can be solved by solutions such as the Truncated Signed Distance Volume (TSDF), which allow a quick merging of range frames and a quick rendering from a given view.

The first successful scanning algorithm was introduced by Newcombe et. al. in Kinectfusion: Real-time Dense Surface Mapping and Tracking in Mixed and Augmented Reality (10th IEEE International Symposium at pages 127-136. IEEE, 2011). The main elements of the Kinectfusion algorithm involves implementing the efficient fast ICP algorithm of Rusinkiewicz and Levoy using a state of the art Graphics Processing Unit (GPU), and the TSDF volume is implemented for fusion and 3D representation.

The problems of ICP with Kinect images were overcome by the ability of the Kinectfusion algorithm to run at a high frame-rate. This means that the frames to be registered are very similar to the preceding frame and then ICP works as intended. However, this algorithm still suffers from several limitations. First, the scanning has to be conducted in a careful way avoiding jerky and fast motions especially if the GPU has less than 512 cores. Second, tracking is prone to failure in flat regions with no enough depth variation. Third, if the tracking is lost, or if the user stops the scanning, the system is not able to recover or resume scanning.

The original Kinectfusion algorithm has been subsequently improved in many directions. For example, there are improved algorithms for removing the limitation on the fixed volume size, reducing the memory foot-print, enhancement by modelling the sensor noise and extension to multiple sensors, and improving the tracking algorithms.

To deal with problem of not having enough depth variation, the ICP algorithm proposed by Steinbrucker et al. (Real-time visual odometry from dense RGB-dimages, In Computer Vision Workshops, 2011 IEEE International Conference at pages 719-722. IEEE, 2011) can be implemented using a GPU, which uses color information in the registration process. They also used visual odometry based on sparse visual features.

ReconstructMe is a commercial system based on the KinectFusion algorithm. The ReconstructMe algorithm is coupled with the commercial system Candelor—a point cloud tracker system—to address the problems of lost tracking and stopping and resume. While the Candelor system is closed, the general approach to registering two point clouds from very different points of view, is to detect salient 3D features—mostly based on height curvature. Then, a 3D descriptor such as the point feature histogram (PFH) is built from the normals to the point cloud at each detected salient feature. Comparing the descriptors of salient features allows to match the features between the two views and subsequently determine the relative pose of the two point clouds which is then refined using ICP.

While Candelor and ReconstructMe solve the problem of tracking failure and resuming after stopping, their solution to this problem is re-active and artificial, meaning that when such a situation is detected the scanning stops, the Candelor system registers the new frame to the already scanned model then the scanning resumes. Furthermore, their system still suffers from the same ICP problem as KinectFusion i.e., sensitivity to fast and jerky motions especially when operating with lower end GPUs.

While the approaches provided above address bits and pieces of the mentioned problems, none of them addresses all of the problems in an efficient way. Accordingly, there is a need for 3D scanners that provide mobile and affordable 3D scanning ability.

### BRIEF DESCRIPTION OF THE DRAWINGS

Various embodiments will now be described, by way of example only, with reference to the following drawings, in which:

FIG. 1 is a schematic diagram of a 3D scanning system according to some embodiments;

FIG. 1A is a schematic diagram of a 3D scanning system according to some other embodiments;

FIG. 2 is a schematic diagram illustrating an object that may be scanned by the scanning system shown in FIG. 1;

FIG. 3 is a schematic diagram illustrating a scene that may be scanned by the scanning system shown in FIG. 1;

FIG. 4 is a schematic diagram illustrating some steps of a scanning method according to some embodiments that may be executed by the processor shown in FIG. 1 for a first frame;

FIG. 5 is a schematic diagram illustrating some steps of a scanning method according to some embodiments that may be executed by the processor shown in FIG. 1 for second and subsequent frames;

FIG. 6 is a schematic diagram illustrating a TSDF volume that may be used to represent data captured by the scanning system of FIG. 1;

FIG. 7 is a schematic diagram illustrating a data structure that may be used to store data associated with the features detected by the scanning system of FIG. 1;

FIG. 8 is a schematic diagram illustrating how information about features detected by the scanning system shown in FIG. 1 could be transferred between frames based upon change in pose of the scanning device; and,

FIG. 9 is a schematic diagram illustrating some steps of a scanning method that may be executed by the processor shown in FIG. 1, according to other embodiments.

### DETAILED DESCRIPTION

For simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments generally described herein.

Furthermore, this description is not to be considered as limiting the scope of the embodiments described herein in any way, but rather as merely describing the implementation of various embodiments as described.

The embodiments described herein attempt to address the problems noted above in a seamless way. By integrating salient depth and colour features with the scene representation and having those features update dynamically with the dense surface various embodiments of the system may provide robustness to jerky and fast motions, as the features allow us to perform registration across large displacements; robustness to frames with little depth variation; improved performance at loop closure even with lower end GPUs; accommodation for varying frame-rates; and accommodation for nosy frames such as those received from low end ToF cameras.

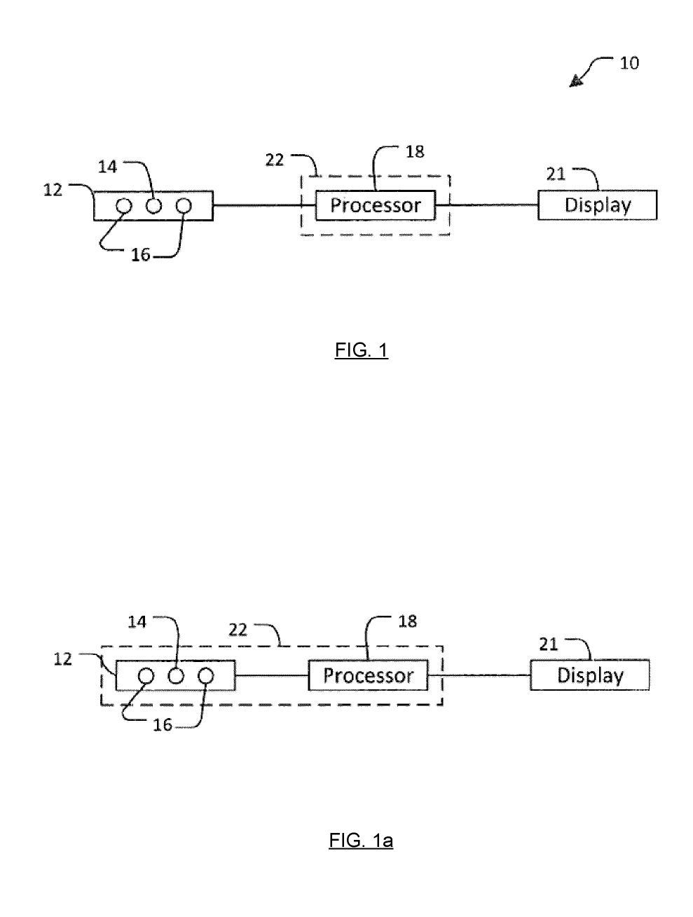

Referring now to FIG. 1, illustrated therein is a 3D scanning system 10 according to some embodiments. The system 10 includes a sensor 12 operatively coupled to a processor 18.

The sensor 12 is configured to generate depth data and image data indicative of a scene. The sensor 12 may comprise more than one sensor. For example, sensor 12 as shown includes an image sensor 14 for generating image data and a depth sensor 16 for generating depth data.

The image sensor 14 may be a camera for generating data in a RGB colour space (i.e. a RGB camera).

The depth sensor 16 may include an infrared laser projector combined with a monochrome CMOS sensor, which captures video data in 3D under any ambient light conditions. The sensing range of the depth sensor may be adjustable and the sensor may be calibrated based upon physical environment to accommodate for the presence of furniture or other obstacles.

The sensor 12 may include a sensor processor coupled to the hardware for capturing depth data and image data. The sensor processor could be configured to receive raw data from the image sensor 14 and the depth sensor 16 and process it to provide image data and depth data. In some cases, the sensor 12 may not include a sensor processor and the raw data may be processed by the processor 18.

In other embodiments, the sensor 12 may include other sensors for generating depth data and image data.

The sensor 12, for example, may be a Kinect™ sensor produced by Microsoft Inc. In contrast to industrial or commercial 3D sensors, the Kinect sensor is a consumer grade sensor designed for use with a gaming console and it is relatively affordable. To date, 24 million units have been sold worldwide thus the Kinect sensor could be found in many homes.

The processor 18 may be a CPU and/or a graphics processor such as a graphics processing unit (GPU). For example, the processor 18 could be consumer grade commercially available GPUs produced by Nividia Corp. or ATI Technologies Inc. such as NVIDIA GeForce™ GT 520M or ATI Mobility Radeon™ HD 5650 video cards respectively. For example, the NVIDIA GeForce GTX 680MX has processing power of 2234.3 GFLOS with 1536 cores.

In some cases, the processor 18 may include more than one processor and/or more than one processing core. This may allow parallel processing to improve system performance.

The system 10 as shown also includes an optional display 21 connected to the processor 18. The display 21 is operable to display 3D data as it is being acquired. The display 21, for example, could be portable display on a laptop, a smart phone, a tablet form computer and the like. In some cases, the display may be wirelessly connected to the system 10. The display could be used to provide real-time feedback to user indicative of the 3D data that has been captured from a scene. This may permit the user to concentrate his/her scanning efforts on areas of the scene where more data are required.

The processor 18 and the sensor 12 could exist independently as shown in FIG. 1. For example, the sensor 12 could be a Kinect™ sensor and the processor 18 could be a CPU and/or a GPU on a mobile portable device such as a laptop, smartphones, tablet computers and the like. The sensor 12 could connect to the processor 18 using existing interfaces such as the Universal Serial Bus (USB) interface. This may be advantageous in situations where a user already has access to one or more components of the system 10. For example, a user with access to a Kinect™ sensor and a laptop may implement the system 10 without needing any other hardware.

The processor 18 and the sensor 12 may also be integrated in a scanning device 22 as shown in FIG. 1A.

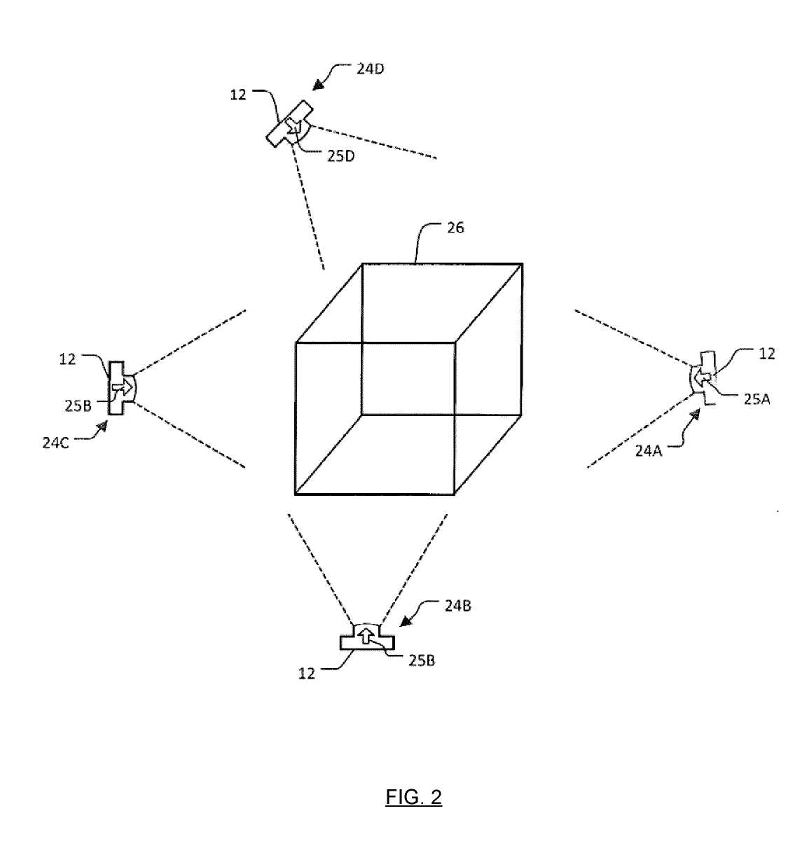

Referring now to FIG. 2, illustrated therein is an exemplary scanning target, which is a 3D object 26. The object 26 may be an object of any shape or size. In the example as shown, the sensor 12 is moved relative to the object 26 to obtain 3D data about the object from various viewpoints. In other embodiments, the objects may be moved relative to the sensor 12. However, as the sensor 12 is portable, it may be easier to move the sensor relative to the target as opposed to moving the target relative to the sensor.

The sensor 12 is moved to positions 24A to 24D about the object 26 to obtain information about the object. The pose of the sensor 12 at each of the positions 24A-24D is indicated by the arrows 25A-25D. That is, each of the sensors could be moved to a position and oriented (e.g. pointed) in a direction. This allows the sensor 12 to obtain data indicative of a 3D representation of the object 26 from various viewpoints.

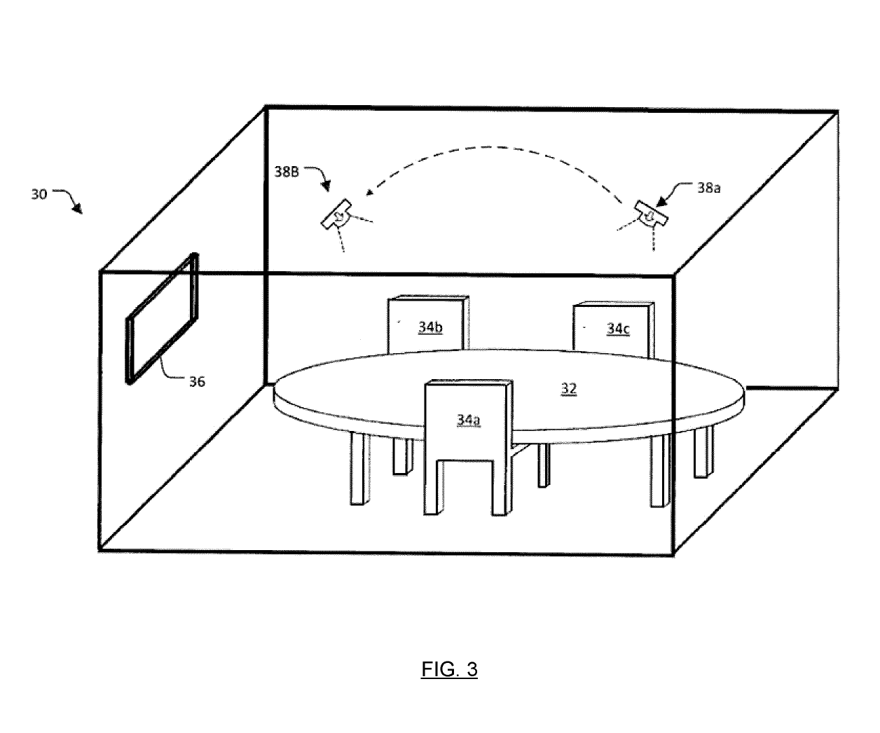

Referring now to FIG. 3, illustrated therein is another exemplary scanning target, which in this case is not an individual object but a scene. The scene in this example is set in a meeting room 30. The room 30 includes, a table 32 and two chairs 34a and 34b. There is a painting 36 on one of the walls. To obtain a 3D scan of the target, the sensor 12 would be moved around the room to scan various features in the room (e.g. the table 32, chairs 34a and 34b, painting 36, walls, etc.). Two exemplary positions 38a and 38b for the sensor are shown. As the sensor is moved around the room, the depth data and image data that is within the operational range of the sensor 12 is captured by the sensor 12 and provided to the processor 18. The processor 18 is configured to process the captured depth data and image data, as described in further detail hereinbelow, to generate data indicative of a 3D representation of the room 30.

The operation of the processor 18 will now be described with reference to method 100 for generating 3D data. The processor 18 may be configured to perform the steps of the method 100 to generate 3D data.

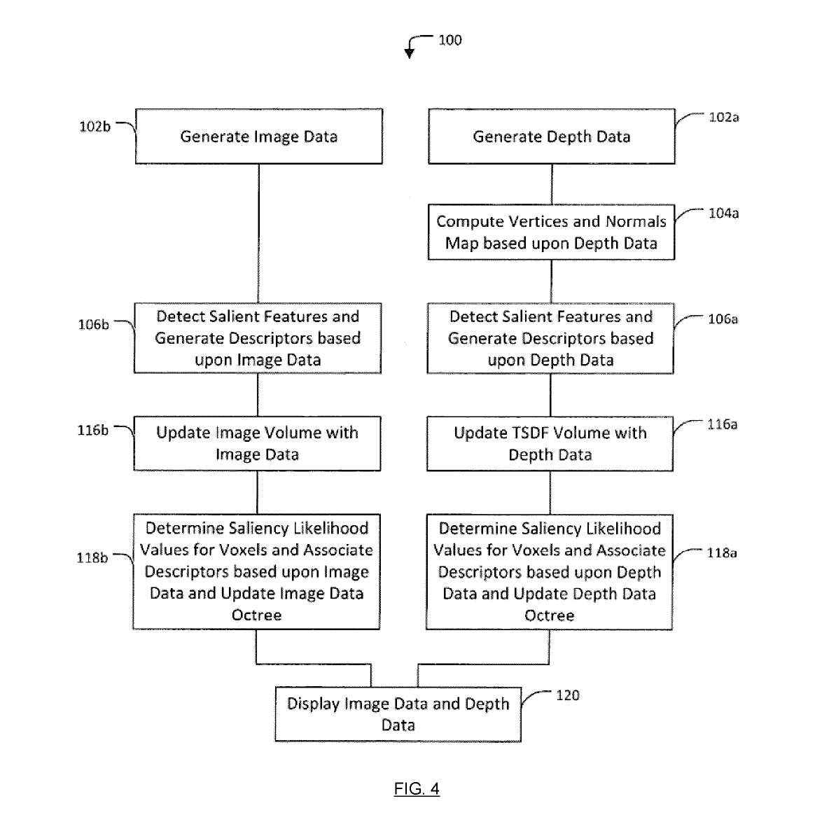

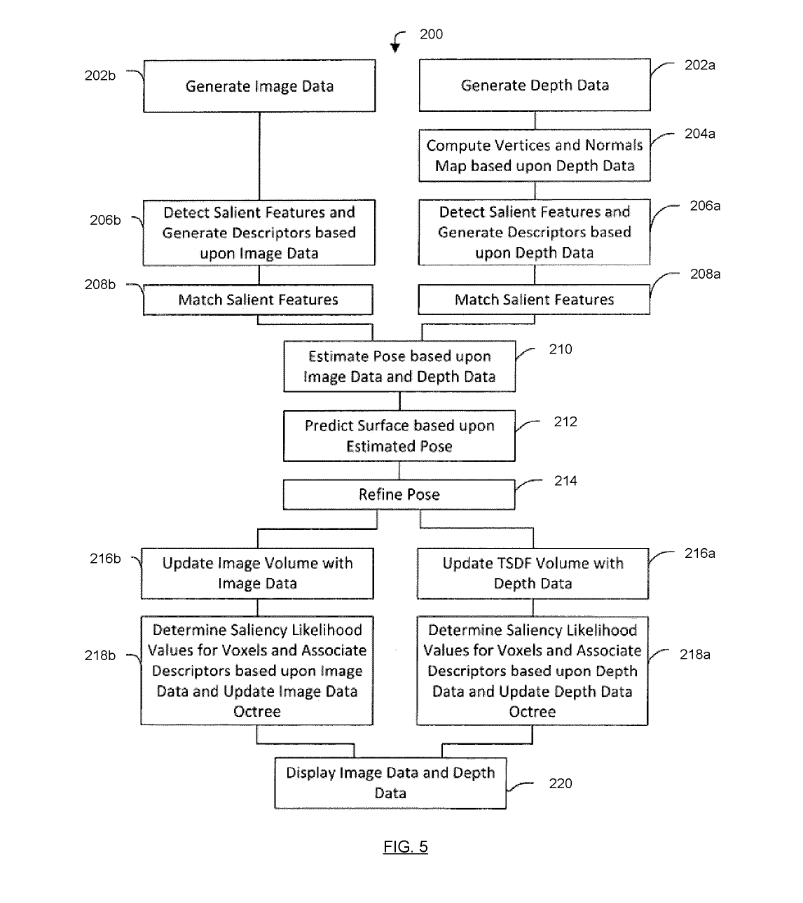

Referring now to FIGS. 4 and 5, illustrated therein are steps of a method 100 and a method 200 for generating 3D data according to some embodiments. The methods 100 and 200 may be performed by the processor 18 to generate 3D data based upon the image data and depth data from the sensor 12.

FIG. 4 illustrates steps of the method 100 that may be performed for the first or initial frame of the captured image and depth data for a scene while FIG. 5 illustrates steps of the method 200 that may be performed for second and subsequent frames. That is, a method may not execute some steps or execute some steps differently for the first frame (i.e. the first instance of capturing image and depth data for a scene) in comparison to second or subsequent frames. For example, according to some embodiments, some of the steps of the method 200 may use data generated by previous iteration of the method 100. However, as there is no previously generated data for the first captured frame, the method 100 may not execute some steps and/or execute some steps differently for the first frame. In contrast, FIG. 5 illustrates various steps of the method 200 that may be executed after the first frame. However, in some cases, depending on how the variables are initialized, the method 200 may be executed as shown in FIG. 5 even for the first frame.

Referring now to FIG. 4, the method 100 for the first frame starts at step 102a and 102b wherein depth data and image data indicative of a scene are generated respectively. The depth data may be generated using a depth sensor and the image data may be generated using an image sensor. In some cases, a sensor may include both a depth sensor and an image sensor. For example, the sensor 12, such as a Kinect™ sensor, could be used to generate the depth data and the image data indicative of a scene. The depth data may be a depth map generated by the sensor. The image data may be color data associated with a scene such as Red Green Blue (i.e. RGB data) data associated with various areas on the sensor.

Each instance of the depth data and the image data of the scene may be referred to as a “frame”. That is, a frame represents the depth data and the image data that are captured for a scene at an instance.

Generally, sensors may record frames periodically. For example, a sensor may record a frame every second or a frame every 1/30 second and so on. If the sensor remains stationary when two consecutive frames are recorded, then the recorded frames should include similar image and depth data. However, if the sensor is moved between consecutive frames, the recorded frames would likely include image and depth data that may contain a lot of differences. Generally, depth data recorded for a frame may be referred to as a “depth frame” or a “range frame” while the image data recorded for a frame may be referred to as an “image frame”. At step 104a, the depth data generated at steps 102a are processed to generate vertices and normal maps. For the depth data, a 3D vertex map may be an array that maps to each element (i, j) a 3D point expressed in a coordinate frame centred at the current sensor position. The vertex map, for example, may be generated from the depth by inverse perspective projection. One way to estimate the normal at a point pᵢ is using principal component analysis on the neighbours of pᵢ. The first two principal directions represent the tangent plane at pᵢ and the third principal direction is the normal.

At steps 106a and 106b, salient features within the scene for depth and image data are detected based upon the vertices and normals map generated at step 104a and 104b respectively, and descriptors are generated for the detected salient features within the depth frame and the image frame.

A salient feature could be a portion of the scene that is different from neighbouring portions. For example, the salient features may be noticeable features within the scene such as the edges of the object 26 shown in FIG. 2, corners and points of high curvature. In another example, the salient features in the exemplary target shown in FIG. 3 may include edges of the chairs, tables etc.

Salient feature detection could be performed using suitable algorithms. For example, the salient feature detection, for example, could be performed using the FAST algorithm described herein above based upon the image data (e.g. the RGB data). The salient feature detection based upon the depth data, for example, could be performed using the NARF algorithm described herein above.

After the salient features are detected, descriptors for the detected salient features may be generated. In some cases, a descriptor may be generated for each salient feature. Generally, descriptors are one or more set of numbers that encode one or more local properties in a given representation of an object or scene.

After the values for the saliency likelihood variables for the depth and image frames have been determined, descriptors may be generated and associated with one or more pixels that have a saliency likelihood value above a certain threshold. A descriptor refers to a collection of numbers that captures the structure of the neighbourhood around the salient feature in a manner that is invariable to scale, orientation or viewing conditions. Those descriptors are often formulated in the form of histogram gradients of pixel intensity or depth gradients centered at the salient feature. A descriptor may be determined by centering an n by n patch (where n is for example 16) on the salient feature detected. This patch is further decomposed into m by m tiles, where m is less than n and is a multiple of n (e.g., m=4). For each tile, we can compute a histogram of its pixel's gradients with 8 bins, each bin covering 45 degrees. For example 16 tiles of 8 histogram bins per tile produce a 128 dimensional vector representing the descriptor. In some cases, the descriptors may include the merged appearance of all the features that coincide with the projections of this voxel in different range frames.

It may not be necessary or desirable to generate a descriptor for the entirety of the captured frame. That is, a descriptor may be generated for and associated with each pixel that has a non-zero likelihood of being a salient feature. Since there may be many pixels that do not include the salient features, the amount of descriptors generated may be limited to the pixels that are likely to include salient features. That is, it may not be necessary or desirable to generate a descriptor for pixels that are not likely to include salient features. This may reduce processing resources required as the amount of descriptors generated may be relatively limited.

Different types of descriptors could be used to represent the salient feature in the image frame or the depth frame. For example, Fast Point Feature Histogram (FPFH) is a descriptor based on a 3D point-cloud representation. In another example, 3D Spin image is a descriptor based upon oriented points. In some embodiments, histogram based descriptors may be implemented to describe the features as descriptors of this type of are generally robust, and they are easy to compare and match. For the image frames, methods based on histograms of gradients such as SIFT and SURF may be used.

After the steps 106a and 106b, the method 100 proceeds to steps 116a and 116b. That is, the method 100 may not execute steps 108a and 108b, 110, 112 and 114 for the first frame and proceeds to steps 116a and 116b, where the depth data and the image data are recorded using appropriate data structures.

A truncated signed distance function (TSDF) volume may be used to capture the depth data at step 116a. The TSDF volume is a data structure that could be implemented in computer graphics to represent and merge 3D iso-surfaces such as a scene captured by the sensor 12.

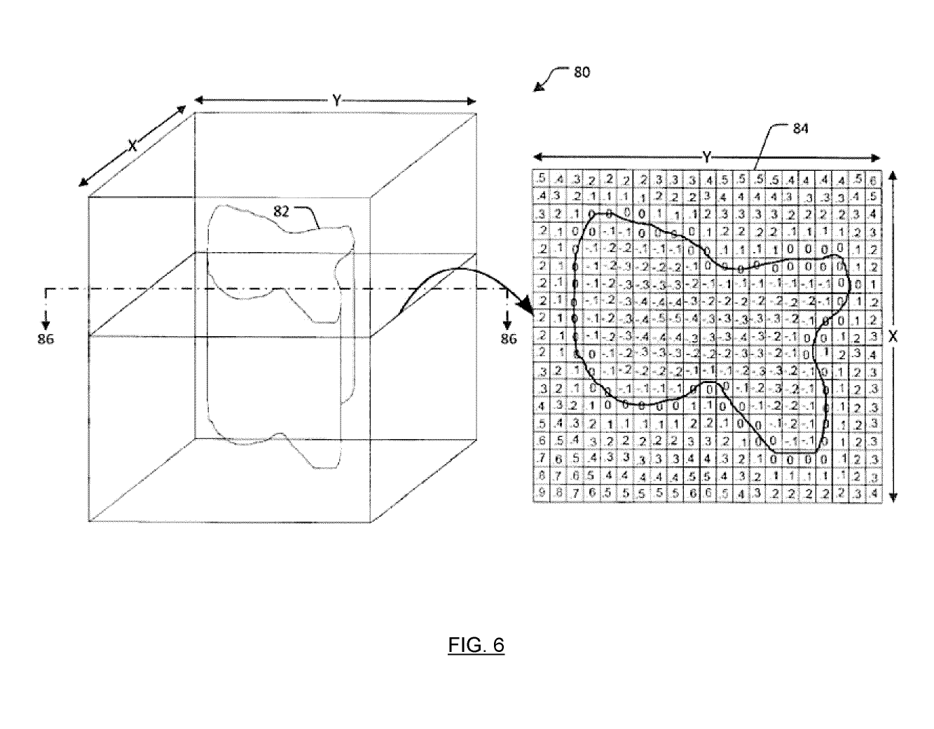

Referring now to FIG. 6, illustrated therein is a volume 80 including an object 82 that may be captured by a sensor such as sensor 12. To represent the volume 80 using TSDF volume, the volume 80 is subdivided in to a plurality of discrete 3D pixels (e.g. cubes/hexahedrons), referred to as “voxels”.

In the example as shown, a layer of voxels taken along the line 86 is represented using the TSDF representation 84. The TSDF representation 84 is a two dimensional array of data. Each signed distance function (“SDF”) value in the array corresponds to one of the voxels taken along line 86. The SDF value of each voxel in the TSDF representation 84 is a signed distance, in the “x” or “y” directions, between the voxel and a surface of the object 82. The “x” and “y” directions correspond to two sides of the cube as shown.

As shown, a SDF value of “0” for a voxel in the TSDF representation indicates that the voxel includes a portion of the surface of the object 82, that is, the voxel is on the surface of the object 82. On the other hand, a value of −0.1 (negative point one) for a voxel indicates that the voxel is one unit within (inside) the surface, and a value of +0.1 (positive point one) for a voxel would indicate that the voxel is one unit outside the surface. Similarly, a value of −0.2 or +0.2 indicate that the voxel is two units away from the surface. In other embodiments, the values may be the distance between the voxel and the surface. In some cases, The SDF values may be truncated above and below a certain value.

The exemplary TSDF representation 84 is indicative of a single layer of voxels. The TSDF representation for the entire volume 80 will include multiple arrays indicative of multiple layers of the voxels.

For the first depth frame, the TSDF volume may be empty as it will not contain any data associated with a previously captured depth frame. However, in some cases there may be data in the TSDF volume or the saliency likelihood variables depending on how the TSDF and the saliency likelihood variables are initialized. For example, there may be null values for the TSDF volume.

In some cases, the TSDF representation for the volume may already contain some values. For example, the TSDF representation for the initial frame may be initialized with some values, or a TSDF representation for second and subsequent frames may include values that are obtained from previous measurements. In such cases, values from the current frame (i.e. new measurement values) may be fused with the existing values (i.e. old values). This can be contrasted from the cases where the values from the current frame replace the old values.

To support fusion of multiple measurements, each TSDF voxel may be augmented with a weight to control the merging of old and new measurement. The following equation (hereinafter referred to as the “Merging Equation”) may be used to combine old and new measurements to generate new values for a voxel:

$${V}_{new} = \frac{{W}_{old} * {V}_{old} + {W}_{n} * {V}_{n}}{{W}_{old} + {W}_{n}}$$

$${W}_{new} = {W}_{old} + {W}_{n}$$

wherein, W_{old} and V_{old} are the old (previously stored) weight and SDF value; Wₙ and Vₙ are the newly obtained weight and SDF value to be fused with the old weight and SDF value; and W_{new} and V_{new} are the new weight and SDF value to be stored.

In some cases, a simple running average may be desired. In such a case, Wₙ could be set to 1 and W_{old} would start from 0. In other cases, Wₙ may be based on a noise model that assigns a different uncertainty to each observed depth value depending on the axial and radial position of the observed point with respect to the sensor.

In some cases, each of the weight and SDF value could be represented using 16 bits, thus each voxel could be represented using 32 bits.

For image data, an image volume could be used to store the image data at step 116b. An image volume may be stored as a 3D array where each voxel (a 3D pixel) stores a color value (RGB for example) associated with the corresponding voxel in the TSDF volume.

After storing the depth data and image data at steps 116a and 116b respectively, the method 100 proceeds to steps 118a and 118b where saliency likelihood values corresponding to each voxel are determined. Generally, a saliency likelihood value for a space unit is indicative of how probable it is for the space unit to include a salient feature. For example, with regards to a voxel based representation of the scanned scene, a saliency likelihood value may indicate how likely it is for a voxel or a group of voxels to include one or more salient features.

The saliency likelihood value may be determined based upon on a number of factors. For example, the saliency likelihood value for a voxel may be determined based upon how proximate the voxel is to the surface of an object. This may be calculated using the equation

$${e}^{- \frac{{( SDF ( {V}_{i} \vert {f}_{c} ) )}^{2}}{{σ}_{sdf}^{2}}}$$

wherein SDF(Vᵢ|f_{c}) is the signed distance function of the voxel Vᵢ given the current frame f_{c} and σ_{sdf} (sigma_{sdf}) is a standard deviation that controls the decay of the saliency likelihood as voxels become farther away from the surface. That is, points that are close to a surface of an object have a higher likelihood of being salient features. For example, voxels with low SDF values (e.g. +/−0.1) in the example shown in FIG. 6 may be assigned a relatively high saliency likelihood value.

In another example, the saliency likelihood value for a voxel may also be determined based upon proximity of the projections of the voxel on each depth frame to salient features detected in the frame, which for example may be calculated using the equation

$$( {e}^{- \frac{{d}^{2}}{{σ}_{d}^{2}}} )$$

wherein d is the distance from the projection to the closest detected feature and σ_{d} (sigma_{d}) is a standard deviation that controls the decay of the saliency likelihood as the projection becomes farther away from a detected feature. This may be, in addition to how salient those detected features are. For example, a voxel whose projection on a certain depth frame falls within 2 pixels from a salient feature detected in this frame would be assigned a likelihood higher than that a voxel whose projection is 3 pixels away from that feature. Similarly, a pixel whose projection is 1 pixel away from a feature detected with a saliency level of 0.6 would be assigned a likelihood higher than that of a voxel whose projection is 1 pixel away of a feature detected with a saliency level of 0.4;

In another example, with regards to image data, saliency likelihood for a voxel may be determined based upon proximity of the projections of the voxel on each image frame to salient features detected in the frame, in addition to how salient those detected features are.

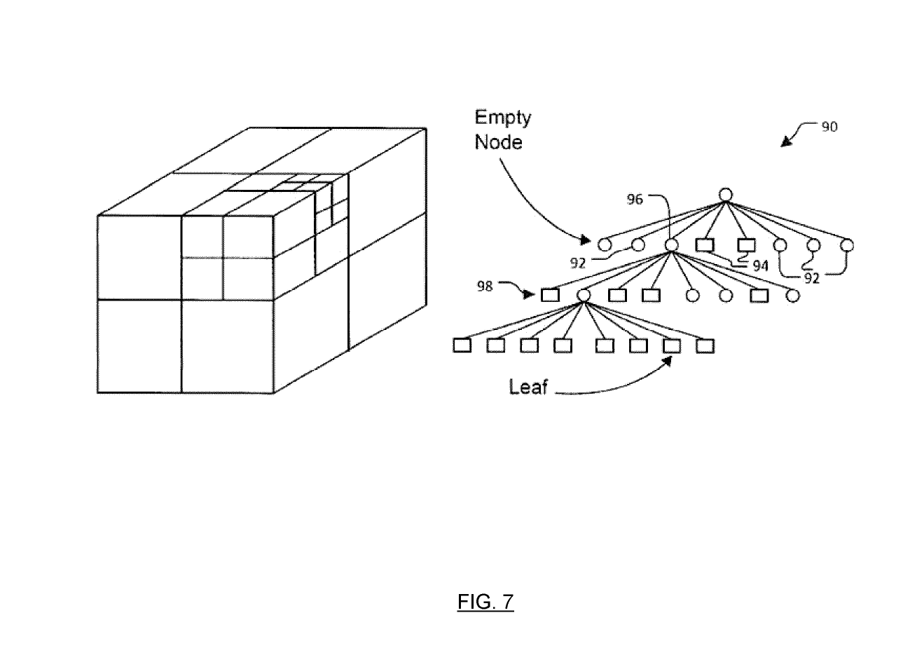

After the saliency likelihood values are determined and the descriptors are generated, the saliency likelihood values and descriptors may be fused in a global scene saliency likelihood representation that associates with every space location a measure of how likely it is for this location to contain a salient feature as well as a descriptor of the 3D structure in the vicinity of this saliency. The scene saliency likelihood representation may be stored using appropriate data structures. For example, the saliency likelihood representation may be stored using an octree-like data structure 90 shown in FIG. 7.

Referring now to FIG. 7, illustrated therein is an octree-like data structure 90 (referred to herein as “octree” for convenience) which may be used to store saliency likelihood variable values and descriptors for image and depth data. If An octree 90 storing data related to depth frame (e.g. the TSDF volume and saliency likelihood values for the depth data) may be referred to as a “depth octree” and an octree 90 storing data related to image frame may be referred to as an “image octree”.

The depth octree 90 subdivides the space corresponding to the TSDF volume into eight octants as shown in FIG. 7. Each of the octants may be empty, contain a salient voxel (i.e. a voxel with a saliency likelihood greater than a specified threshold, for e.g. a non-zero likelihood of including a salient feature), or contain more than one salient voxel. An empty octant may be represented by an empty node 92, a salient voxel in the depth octree 90 may be represented by a non-empty leaf node 94, and multiple salient voxels are represented by a node 96 associated with a sub-octree 98.

Each of the non-empty leaf nodes 94 may include a descriptor that consists of a histogram represented as a set of integer binary numbers (125 for example).

The non-empty leaf node 94 may also include a saliency likelihood value Sᵥ that represents the average saliency of the corresponding voxel as seen from different viewpoints.

The non-empty leaf node 94 may also include an averaging weight value that could be used to compute the running average of the saliency likelihood value.

Each of the non-leaf nodes (e.g. the node 96) may include a maximum saliency likelihood associated with all the children in this node. The node may also include an index of the sub-octree (e.g. the index to locate the sub-octree 98) that contains the element with the maximum saliency likelihood value.

Using the octree 90 to store the saliency likelihood values for a space and associated descriptors (if any) may be advantageous. For example, it may be relatively simple to determine whether a given octant contains a salient feature by examining a node of the octree associated with the octant.

The method proceeds to step 120 wherein image data and depth data are displayed on a display device. The displayed image data and depth data may be a three dimensional rendering of the captured frame.

Referring now to FIG. 5, illustrated therein are steps of the method 200 that may be executed for frames other than the first frame to generate 3D data for a scene. Similar to the method executing for the first frame described herein above, the method starts at steps 202a and 202b, 204a and 204b and 206a and 206b wherein image data and depth data are processed. After the steps 206a and 206b, the method continues to steps 208a and 208b respectively.

At steps 208a and 208b, salient features detected within the depth frame and image frame at steps 206a and 206b are matched with the saliency likelihoods distribution representation, which is based on the salient features detected for one or more previously recorded frames. For example, the salient features may be matched with salient features that may be stored in an octree 90 described hereinbelow.

To match the salient features with the saliency likelihoods distribution representation, it may be assumed initially that the displacement of the sensor between frames is minimal. That is, it is first assumed that the camera has only been moved minimally. Assuming that the salient features are stationary between frames, this window of possible pose movement constrains the search space for each detected feature to a region centred around where this feature would be if the camera was at the previous estimated camera position. The search regions are assumed to have initially small radii (for example 4 voxels) based on the assumption of small camera displacement. Each detected feature, is compared to all the stored features in the saliency likelihoods representation (octree) that fall within its corresponding search space. If none of the stored features is a match, the search volume can be increased and the search repeated. In some cases, the extent of the search radius may be limited to a defined maximum number of voxels and if the feature is not located within the maximum volume, the feature may be declared as not found.

For previously determined features to be selected as a match for a certain newly detected feature, it may be required that the saliency likelihood values associated with the voxels that include the features have to be higher than a predefined threshold.

In some cases, the saliency likelihood values used may be a local maxima in that the saliency likelihood values for the voxel including the feature is higher than the saliency likelihood values of neighbouring voxels within a certain distance.

The octree-like data structure such as the octree 90 shown in FIG. 7 may enable efficient determination of candidate features that satisfy the above noted conditions regarding the saliency likelihood. For example, the non-empty leaf nodes (e.g. nodes 94) include saliency likelihood values for the voxels associated with the nodes. Furthermore, a non-leaf node (e.g. node 96) stores the maximum saliency likelihood of all of the children of that node. This allows the method 200 to effectively determine the local maxima for the octant associated with the node.

Features comparison during the search phase is performed based upon the any distance measure between the descriptors. For example, Euclidean distance between the descriptors for the features may be used. Two descriptors associated with the features may be considered as a match if the Euclidean distance between the descriptors is below a selected threshold.

At step 210, after the newly detected salient features are matched to the salient features in the octree 90 the current pose of the sensor in relation to the TSDF volume can be determined as a ridged transformation between the two sets of features. Estimation of the pose could be conducted based upon matched salient features from the depth frame alone (i.e. without the data related image frame). However, estimating the pose based upon matched salient from the depth frame and the image frame could result in a more accurate estimation.

The estimation of the current pose of the camera could be executed using known algorithms, such as the algorithms described by D. W. Eggert, A. Lorusso, R. B. Fisher in Estimating 3D rigid body transformations: a comparison of four major algorithms (Machine Vision and Applications, Vol. 9 (1997), pp. 272-290). The estimation can be made resilient to outliers using a robust estimation technique such as the RANSAC algorithm as described by M. A. Fischler and R. C. Bolles in Random sample consensus: a paradigm for model fitting with applications to image analysis and automated cartography (Communications of the ACM, 24(6):381-395, 1981).

Another possible approach to detect outliers is to look at pairwise distance consistencies. The distance between every two detected features should be equal to the distance between their matches in the octree. If two features violate this, one of them may be an outlier. A way to detect outliers that violate pairwise rules is described by A. Howard in Real-time stereo visual odometry for autonomous ground vehicles (IEEE/RSJ International Conference on Intelligent Robots and Systems, 2008. IROS 2008., pages 3946-3952).

After an estimate of the current pose for the sensor is obtained, the scene as it may be observed from the estimated pose is predicted at step 212. That is, the method 200 generates a prediction of the scene that can be captured from the estimated pose.

At step 214, the estimated pose determined from step 210 is refined. For example, the observed surface may be aligned to the projected surface using Iterative Closest Point (ICP). For example, algorithm described in Steinbrucker et al. described hereinabove may be implemented to refine the estimated pose of the camera. In another example, algorithm described by Erik Bylow et al. in the publication entitled “Real-Time Camera Tracking and 3D Reconstruction Using Signed Distance Functions” (Robotics: Science and Systems Conference (RSS), 2013) may be used.

After the camera pose is known, the current depth and image data are recorded at steps 216a and 216b by updating the image volume with image data and updating the TSDF volume with depth data. The volumetric representation of the scene may be updated based on the current depth data and image data (in steps 216a and 216b, respectively), and the refined estimated pose. The saliency likelihoods distribution representation may be updated based on the salient features for the current depth frame and the refined estimated pose.

To record the depth data, the depth data for the current depth frame may be fused with the data stored in the TSDF which is indicative of the depth data for all the previously recorded frames.

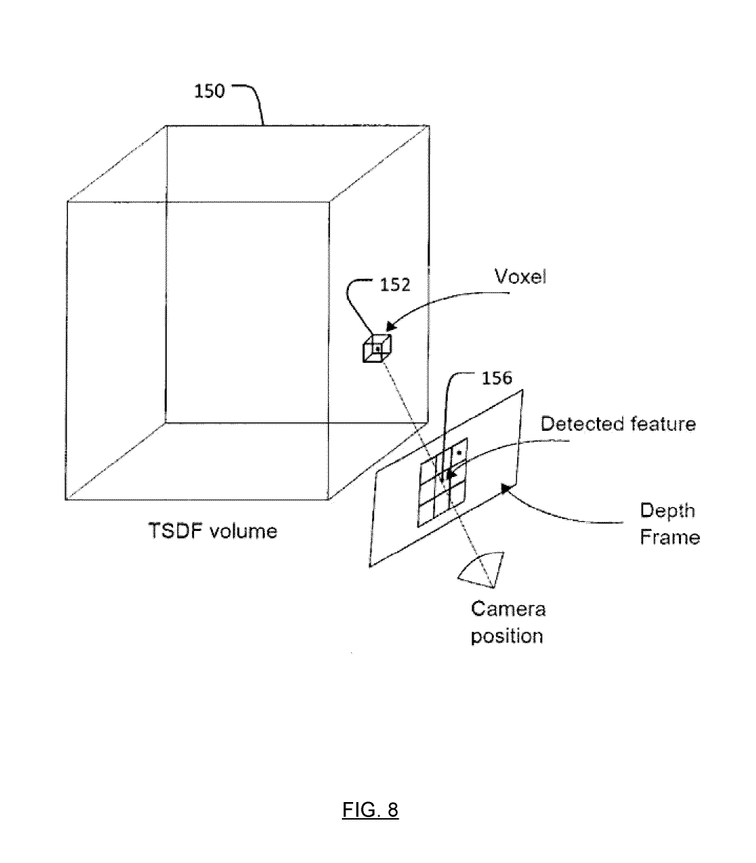

Referring now to FIG. 8, illustrated therein is an exemplary TSDF volume 150 that may be fused in step 116a. For every voxel Vᵢ in the TSDF volume (e.g. voxel 152), a corresponding 3D value point 154 is determined, and then transformed into camera frame f_{c} 156. The new measured SDF value SDF(Vi|f_{c}) may be computed as the difference between the depth value at the projection of this point on the depth frame minus the distance from the camera centre to the 3D point. The new SDF value is merged with the new one using the Merging Equation described herein above.

To fuse the features saliency data obtained for the current frame with the saliency likelihood distribution representation stored in the octree 90, a similar process as the process described above could be used to determine the projection of every voxel Vᵢ on the current depth frame. Then if this projection is within a certain distance from a detected feature, a saliency likelihood value of the voxel Vᵢ given the current frame f_{c} is determined as:

$$S ( {V}_{i} \vert {f}_{c} ) = {S}_{feature} \times ( {e}^{- \frac{{d}^{2}}{{σ}_{d}^{2}}} ) ( {e}^{- \frac{{( SDF ( {V}_{i} \vert {f}_{c} ) )}^{2}}{{σ}_{sdf}^{2}}} )$$

wherein, d is the distance from the projection to the closest detected feature, S_{feature} is the saliency measure of the closest detected feature returned by the feature detector and σ_{d} (sigma_{d}) and σ_{sdf} (sigma_{sdf}) are standard deviations that control the relative contribution of the detected feature saliency, the distance to this feature and the measured SDF to the overall saliency likelihood value. If no feature is detected within a certain threshold of the projection of the voxel Vᵢ, the saliency likelihood value of this voxel given the current frame f_{c} is set to 0. If this voxel had already an element associated to it in the octree, then this element may be updated as follows. The new descriptor is merged with the old descriptor by a weighted averaging with the old saliency likelihood value and the new saliency likelihood value. The saliency likelihood value may be merged with the old one using a running average using the Merging Equation described herein above.

If the new likelihood value is greater than the parent value, the parent likelihood and index are changed respectively to the current element likelihood and index. The change is propagated up in the tree until the likelihood of the parent is higher than the current node.

If the current voxel does not have a corresponding element in the octree, a new element may be created as follows.

The descriptor is set to the descriptor of the closest feature. The saliency is set to S_{combined} and its weight to 1.

If the new likelihood value is greater than the parent value, the parent likelihood and the index are changed respectively to the current element likelihood and index. The change is propagated up in the tree until the likelihood of the parent is higher than the current node.

At step 216b, the image volume is updated with the image data. Each voxel value is updated using a running average on the RGB pixel with the new weight Wₙ^{c} derived from the new computed TSDF value (SDF(Vi|fc)) and its corresponding weight Wₙ. The new image weight Wₙ^{c} can be for example the new computed TSDF weight multiplied by a function of the TSDF value that decays from 1 (for SDF(Vi|fc)=0) to 0 (for SDF(Vi|fc)=1). An example of such function is exponential decay as follows:

$${W}_{n}^{c} = {W}_{n} \times {e}^{- \frac{{( SDF ( {V}_{i} \vert {f}_{c} ) )}^{2}}{{σ}_{sdf}^{2}}}$$

To minimize outliers, a running median filter can be used for robustness. Rather than fusing RGB values, HSV (Hue, Saturation, brightness Value) can be used to encode colour properties.

At step 218a and 218b, the method 200 stores the image data and depth data associated with the current frame, the method proceeds to steps 218a and 218b wherein saliency likelihood values are determined and associated descriptors are generated as described above.

At step 220, the image data and depth data are displayed on a display device. In some cases, the displayed data may be based upon the data associated with the predicted surface that was generated at step 212.

The method 200 may then return to steps 202a and 202b to capture the next frame.

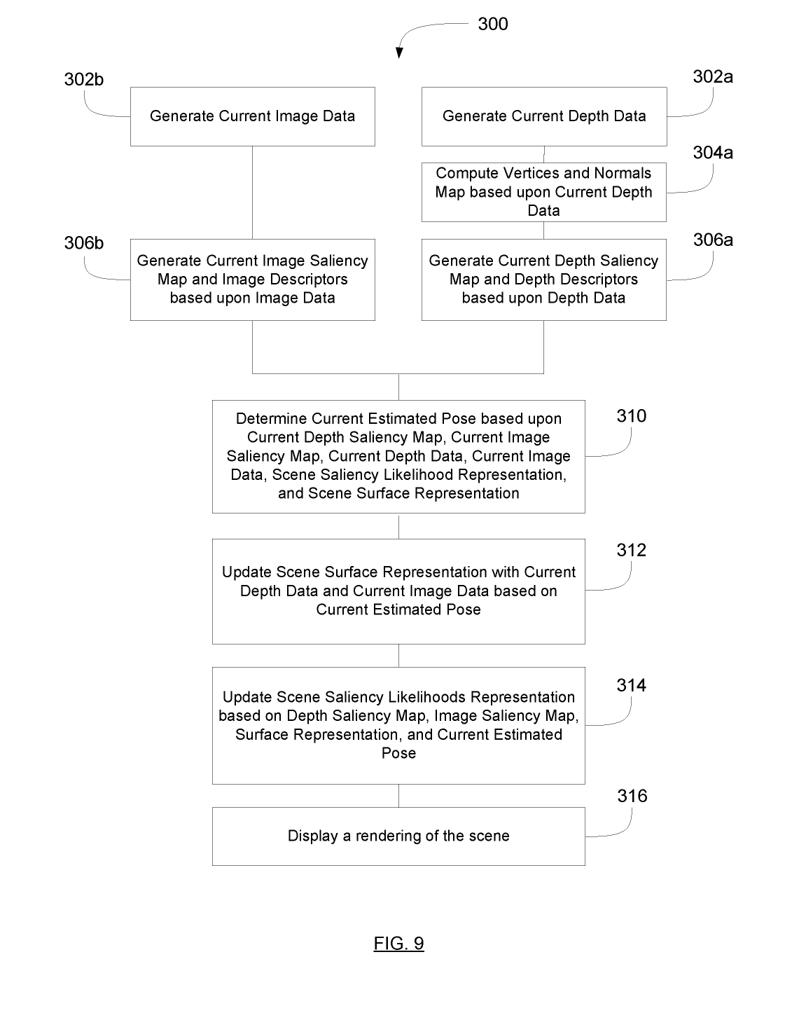

Referring now to FIG. 9, illustrated therein are steps of a method 300 for generating 3D data according to other embodiments. The method 300 may be performed by the processor 18 to generate 3D data based upon the image data and depth data from the sensor 12.

The method 300 starts at step 302a and 302b wherein current depth data and current image data indicative of a scene are generated, respectively, and analogously to steps 202a and 202b of method 200 in FIG. 5. The method 300 proceeds through step 304a in a similar manner as step 204a of method 200.

At steps 306a and 306b, current saliency maps and descriptors are generated based on the current depth data and current image data, respectively. Saliency maps represent a saliency value for each pixel in a frame. Whereas some embodiments may rely on salient features, which may, in some cases, represent a subset of all saliency values for a frame, the method 300 uses saliency maps.

After steps 306a and 306b, the method 300 proceeds to step 310. At step 310, a current estimated sensor pose is determined based upon aligning the saliency maps generated in steps 306a and 306b with the scene saliency likelihood representation, and aligning the current depth and image data with the scene surface representation.

The scene saliency likelihood representation comprises the accumulation of previously-generated saliency maps. In essence, the scene saliency likelihood representation represents the currently-modelled saliency likelihoods for the 3D scene, as at the time that the current depth and image data are generated. According to some embodiments, the scene saliency likelihood representation may be stored in an octree-like data structure. Furthermore, a scene saliency likelihoods distribution representation may be used, which represents the distribution of the saliency likelihoods within the modelled scene.

The scene surface representation comprises the accumulation of previously-generated depth data and image data. In essence, the scene surface representation represents the currently-modelled surface for the 3D scene, as at the time that the current depth and image data are generated. According to some embodiments, the scene surface representation may be an implicit volumetric surface representation such as a truncated signed distance function (TSDF) and stored in an volumetric data structure such as a TSDF volume.

Method 300 may be used to generate the initial or first-generated current depth and image data. In this case, step 310 may be altered such as to not rely upon aligning the current saliency maps with the scene saliency likelihood representation. Similarly, step 310 may be altered such as to not rely upon aligning the current depth and image data with the scene surface representation. If the method 300 is used to generate the initial depth and image data, then the scene saliency likelihood representation and scene surface representation will be null.

In some cases, an arbitrary or initial estimated pose may be assumed at step 310, when method 300 is generating an initial frame. For example, in the case of the initial frame, an origin value or initial reference value may be assigned as the current estimated pose. Upon subsequent iterations of method 300, the current estimated pose, as determined at step 310, may be determined as a current estimated pose relative to the initial reference or origin.

At step 312, the method updates a scene surface representation, using the current image data and current depth data. Since a sensor pose was estimated at step 310 (or, since the sensor pose may be arbitrarily defined for an initial frame), the depth data and image data generated at steps 302a and 302b, respectively, can be appropriately added to the surface representation based on the current estimated pose. In this way, the scene surface representation will be up-to-date for the subsequent iteration of method 300.

As previously described for steps 216a and 216b of method 200, the depth data and image data may be recorded using appropriate data structures. Furthermore, any surface representation may be used, including, but not limited to a TSDF representation.

After step 312, the method proceeds to step 314, where the scene saliency likelihood representation is updated. The scene surface representation and the current estimated pose of the sensor may also contribute to the updating of the scene saliency likelihoods representation. In this way, the scene saliency likelihoods representation will be up-to-date for the subsequent iteration of method 300.

At step 316, a 3D representation of the scene may be rendered using the current saliency maps, depth data, image data, surface representation, and estimated pose. This is analogous to step 220 of method 200.

It should be understood that the methods 100, 200, and 300 according to some embodiments described herein above are only for illustrative purposes. In other embodiments, one or more steps of the above described methods may be modified. In particular, one or more of the steps may be omitted, executed in a different order and/or in parallel, and there may be additional steps.

While the above description provides examples of one or more apparatus, methods, or systems, it will be appreciated that other apparatus, methods, or systems may be within the scope of the present description as interpreted by one of skill in the art.

In some cases, the embodiments of the systems and methods described herein may be implemented in hardware or software, or a combination of both. In some cases, embodiments may be implemented in one or more computer programs executing on one or more programmable computing devices comprising at least one processor, a data storage device (including in some cases volatile and non-volatile memory and/or data storage elements), at least one input device, and at least one output device.

In some embodiments, each program may be implemented in a high level procedural or object oriented programming and/or scripting language to communicate with a computer system. However, the programs can be implemented in assembly or machine language, if desired. In any case, the language may be a compiled or interpreted language.

In some embodiments, the systems and methods as described herein may also be implemented as a non-transitory computer-readable storage medium configured with a computer program, wherein the storage medium so configured causes a computer to operate in a specific and predefined manner to perform at least some of the functions as described herein.

Moreover, the scope of the claims appended hereto should not be limited by the embodiments set forth in the examples, but should be given the broadest interpretation consistent with the description as a whole.

1. A computer-implemented method for generating three-dimensional (“3D”) data, the method comprising:
(a) generating depth data indicative of a scene using a sensor, the depth data being associated with a current depth frame;
(b) detecting salient features within the current depth frame based upon the depth data;
(c) matching the detected salient features for the current depth frame with a saliency likelihoods distribution representation of the scene generated from previously detected salient features for a previously generated depth frame;
(d) determining an estimated pose of the sensor based upon the matching of detected salient features;
(e) refining the estimated pose based upon a volumetric representation of the scene; and
(f) updating the volumetric representation of the scene based on the current depth data and the refined estimated pose and updating the saliency likelihoods distribution representation based on the salient features for the current depth frame and the refined estimated pose.

2. The method of claim 1, wherein matching the detected salient features for the current frame with previously detected salient features for a previously generated frame comprises:
(a) obtaining previously estimated position and direction of the at least one sensor associated with the previously recorded salient features;
(b) determining uncertainty area based upon the previously estimated position and direction of the at least one sensor, the uncertainty area being indicative the estimated position and direction of the at least one sensor;
(c) identifying candidate features from the previously recorded salient features based upon whether these features can be detected if the at least one sensor is within the uncertainty area;
(d) comparing the candidates features to the detected salient features; and
(e) determining the estimated position and direction of the at least one sensor based upon the candidate features that match the detected features above a match threshold.

3. The method of claim 2, further comprising:
(a) determining saliency likelihood values for discrete spaces within a frame;
(b) generating descriptors for spaces that have the saliency likelihood values above a specified threshold; and
(c) storing the descriptors for use as the candidate features.

4. The method of claim 3, wherein at least one of the saliency likelihood values and the descriptors are stored based upon an oct-tree like data structure.

5. The method of claim 3, wherein the candidate features are identified based upon local maxima of the saliency likelihood values.

6. The method of claim 5, wherein the descriptor is a Histogram based descriptor.

7. The method of claim 1, wherein:
step (a) further comprises generating image data indicative of the scene using the sensor, the image data being associated with a current image frame;
step (b) further comprises detecting salient features for the image data within the current image frame based upon the image data; and,
step (c) further comprises matching the detected salient features for the image data with the previously detected salient features for the image data.

8. The method of claim 7, wherein the salient features from the image data is detected using FAST algorithm.

9. The method of claim 7, wherein the descriptors for the salient features from the image data is generated using SURF algorithm.

10. The method of claim 6, wherein the salient features from the depth data is detected using NARF algorithm.

11. The method of claim 6, wherein the descriptors for the salient features from the depth data is generated using PFH algorithm.

12. The method of claim 7, wherein the depth data and image data is recorded by merging with the depth data and image data with previously recorded depth data and image data.

13. The method of claim 12, wherein at least one of the depth data is merged with at least one of the previously recorded depth data and image data using the equation:
$${V}_{new} = \frac{{W}_{old} * {V}_{old} + {W}_{n} * {V}_{n}}{{W}_{old} + {W}_{n}}$$
$${W}_{new} = {W}_{old} + {W}_{n}$$
wherein, W_{old} and V_{old} are the old (previously stored) weight and SDF value; Wₙ and Vₙ are the newly obtained weight and SDF value to be fused with the old weight and SDF value; and W_{new} and V_{new} are the new weight and SDF value to be stored.

14. A system for generating three-dimensional (“3D”) data, the system comprising:
(a) at least one sensor for generating depth data indicative of a scene;
(b) a processor operatively coupled to the at least one sensor, the processor configured for:
(i) generating depth data indicative of a scene using a sensor, the depth data being associated with a current depth frame;
(ii) detecting salient features within the current depth frame based upon the depth data;
(iii) matching the detected salient features for the current depth frame with a saliency likelihoods distribution representation of the scene generated from previously detected salient features for a previously generated depth frame;
(iv) determining an estimated pose of the sensor based upon the matching of detected salient features;
(v) refining the estimated pose based upon a volumetric representation of the scene; and
(vi) updating the volumetric representation of the scene based on the current depth data and the refined estimated pose and updating the saliency likelihoods distribution representation based on the salient features for the current depth frame and the refined estimated pose.

15. The system of claim 14, wherein the processor is further configured to match the detected salient features for the current frame with previously detected salient features for a previously generated frame by:
(a) obtaining previously estimated position and direction of the at least one sensor associated with the previously recorded salient features;
(b) determining uncertainty area based upon the previously estimated position and direction of the at least one sensor, the uncertainty area being indicative the estimated position and direction of the at least one sensor;
(c) identifying candidate features from the previously recorded salient features based upon whether these features can be detected if the at least one sensor is within the uncertainty area;
(d) comparing the candidates features to the detected salient features; and
(e) determining the estimated position and direction of the at least one sensor based upon the candidate features that match the detected features above a match threshold.

16. The system of claim 15, wherein the processor is further configured for:
(a) determining saliency likelihood values for discrete spaces within a frame;
(b) generating descriptors for spaces that have the saliency likelihood values above a specified threshold; and
(c) storing the descriptors for use as the candidate features.

17. The system of claim 14, wherein the at least one sensor is a handheld portable 3D sensor.

18. The system of claim 17, wherein the at least one sensor is a Kinect™ sensor.

19. The system of claim 14, wherein the processor comprises a graphics processing unit.

20. The system of claim 14, wherein the at least one sensor is a handheld sensor and the at least one processor is a processor in a mobile computing device.

21. A computer-implemented method for generating three-dimensional (“3D”) data, the method comprising:
(a) generating current depth data and current image data indicative of a scene using at least one sensor;
generating a current depth saliency map and current depth descriptors based upon the current depth data, and generating a current image saliency map and current image descriptors based upon the current image data;
(b) determining a current estimated pose of the at least one sensor based on aligning the current saliency maps with a scene saliency likelihoods representation, and aligning the current depth and image data with a scene surface representation;
(c) updating the scene surface representation based on the current depth data, the current image data, and the current estimated pose; and,
(d) updating the scene saliency likelihoods representation based on the current saliency maps and the current estimated pose.
